(19) United States
(12) Patent Application Publication
(10) Pub. No.: US 2025/0020865 A1
(43) Pub. Date: Jan. 16, 2025

(54) Waveguide-Type Optical Coupler

(71) Applicant: Nippon Telegraph and Telephone Corporation, Tokyo (JP)

(72) Inventors: Takashi Go, Musashino-shi, Tokyo (JP); Kenya Suzuki, Musashino-shi, Tokyo (JP); Keita Yamaguchi, Musashino-shi, Tokyo (JP); Ai Yanagihara, Musashino-shi, Tokyo (JP)

(21) Appl. No.: 18/710,066

(22) PCT Filed: Dec. 1, 2021
(86) PCT No.: PCT/JP2021/044134

§ 371 Date: May 14, 2024

(51) Int. Cl. G02B 6/28

(52) U.S. Cl. CPC G02B 6/2821

(57) ABSTRACT

There is provided a waveguide type optical coupler that maintains a constant branching ratio in a wide wavelength region without wavelength dependency and polarization dependency. A waveguide type optical coupler includes a Mach-Zehnder interferometer that includes two arm waveguides between two directional couplers. In the waveguide type optical coupler, waveguide widths of the two waveguides in a coupling portion of the directional coupler are different from each other.

### TECHNICAL FIELD

The present invention relates to an optical coupler used in an optical waveguide device.

### BACKGROUND ART

An optical coupler is an important circuit element in configuring an optical function device. As a waveguide type optical coupler, a directional coupler that is configured by extending two waveguides to be close to each other and transfers optical power from one waveguide to the other waveguide by adiabatic coupling of optical fields propagating through one waveguide is known. However, in the optical field, an amount of light leaked from the waveguide varies depending on a wavelength of the light. As a result, wavelength dependency is produced in a coupling ratio (branching ratio).

FIG. 1 illustrates a wavelength characteristic of a typical waveguide type optical coupler in the related art. A waveguide type optical coupler that is configured with the directional coupler is designed such that a branching ratio is 50% at a wavelength of approximately 1.53 μm, that is, a transmission loss is 3 dB. However, in a wavelength band used in optical communication, that is, a wavelength of 1.3 μm to 1.65 μm, a transmission loss changes at a transmission ratio of −7 dB (branching ratio 20%) to −1.6 dB. Such wavelength dependency is observed as a difference in optical power for each wavelength channel in a case where the optical coupler is applied to wavelength division multiplexing communication. The difference in optical power needs to be compensated for in an optical communication system, and this is a problem in configuring the system.

In order to solve such a problem, a wavelength independent coupler (WINC) that reduces wavelength dependency using a Mach-Zehnder interferometer has been proposed (refer to, for example, Non Patent Literature 1). In the WINC, an optical path length difference is provided between two waveguides included in an arm portion of a Mach-Zehnder interferometer, and coupling ratios of two directional couplers configuring the Mach-Zehnder interferometer are appropriately set. Thus, a flat coupling characteristic is obtained in a target wavelength band.

FIG. 2 illustrates a configuration of the WINC in the related art. The WINC 10 includes two arm waveguides 13 and 14 between two directional couplers 11 and 12. An optical path length difference ΔL is provided between the arm waveguide 13 (long arm) and the arm waveguide 14 (short arm). The two waveguides configuring the directional couplers 11 and 12 have the same waveguide width. A coupling ratio κ₁ of the directional coupler 11 and a coupling ratio κ₂ of the directional coupler 12 are appropriately set such that a transmission loss is 3 dB (branching ratio of 50%) at a wavelength in a wavelength band (1.3 μm to 1.65 μm) used in optical communication. Note that the coupling ratio of the directional coupler is determined by a length (coupling length) of a coupling portion at which the two waveguides are brought close to each other, a distance between the waveguides, and a waveguide width.

FIG. 3 illustrates a wavelength characteristic of the WINC in the related art. This is a result obtained by calculating a wavelength characteristic of the WINC based on the parameters. The transmitted light has a flat characteristic at a transmittance ratio of −3 dB. On the other hand, each of TE polarization and TM polarization has a polarization dependent loss (PDL) over the wavelength band. This is because the coupling ratio of the directional coupler configuring the WINC has polarization dependency. Polarization dependent transmittance (PDT), which is a difference between the TE polarization and the TM polarization, has polarization dependency of approximately 0.1 dB over the wavelength band.

For example, in the WINC using a silica-based planar lightwave circuit manufactured through a high-temperature heat treatment such as a flame deposition method, it is considered that the polarization dependency of the coupling ratio of the directional coupler is caused by the following reasons. That is, due to an internal stress of the optical waveguide during the heat treatment, a difference in the internal stress is produced between a direction of a substrate and a direction perpendicular to the substrate. Due to the difference in the internal stress, double refraction occurs inside the directional coupler, and polarization dependency is produced. On the other hand, also in an optical waveguide made of a ferroelectric crystal such as LiNbO₃, double refraction occurs based on the crystal orientation, and polarization dependency is similarly exhibited. In addition, also in an optical semiconductor waveguide such as InP, since the optical semiconductor waveguide is a waveguide using a crystal, polarization dependency is similarly produced.

### CITATION LIST

### Non Patent Literature

Non Patent Literature 1: K. Jinguji; N. Takato; A. Sugita; M. Kawachi, “Mach-Zehnder interferometer type optical waveguide coupler with wavelength-flattened coupling ratio”, Volume 26, Issue 17, 16 Aug. 1990, p. 1326-1327

### SUMMARY OF INVENTION

An object of the present invention is to provide a waveguide type optical coupler that maintains a constant branching ratio in a wide wavelength region without wavelength dependency and polarization dependency.

In order to achieve the object, according to the present invention, there is provided a waveguide type optical coupler including: a Mach-Zehnder interferometer that includes two arm waveguides between two directional couplers, in which waveguide widths of the two waveguides in a coupling portion of the directional coupler are different from each other.

### BRIEF DESCRIPTION OF DRAWINGS

FIG. 1 is a diagram illustrating a wavelength characteristic of a waveguide type optical coupler in the related art.

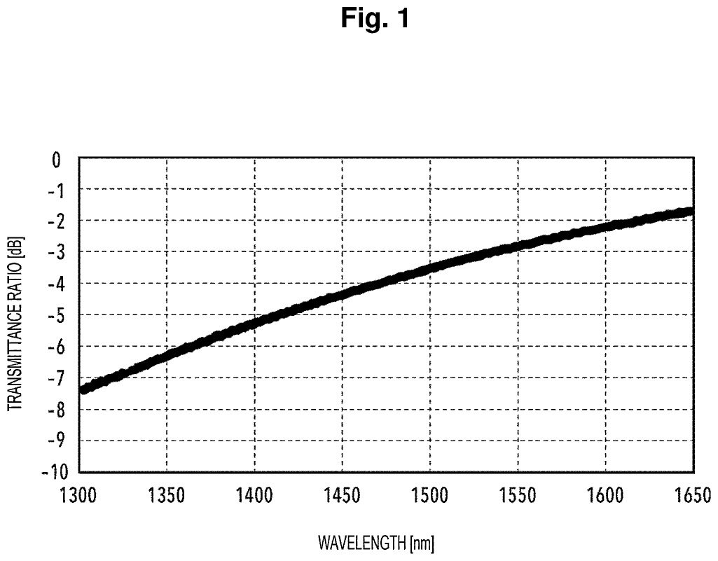

FIG. 2 is a diagram illustrating a configuration of a WINC in the related art.

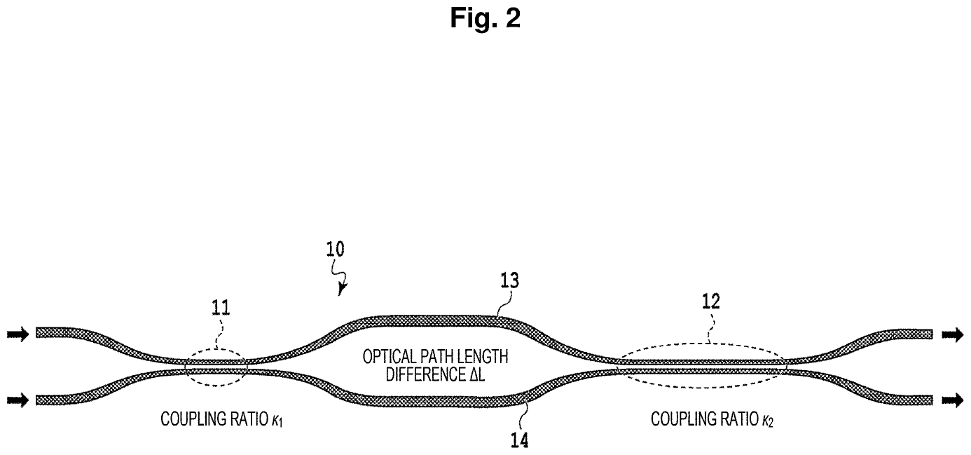

FIG. 3 is a diagram illustrating a wavelength characteristic of the WINC in the related art.

FIG. 4 is a diagram illustrating a configuration of a WINC according to a first embodiment.

FIG. 5 is a diagram illustrating a configuration of a WINC according to a second embodiment.

FIG. 6 is a diagram illustrating a wavelength characteristic of the WINC according to the second embodiment.

### DESCRIPTION OF EMBODIMENTS

Hereinafter, an embodiment of the present invention will be described in detail with reference to the drawings. In the present embodiment, an example using a silica-based optical waveguide will be described. On the other hand, a material of the waveguide is not specified. The present embodiment can be applied not only to a silica-based optical waveguide but also to a waveguide using another material, such as a silicon (Si) waveguide, an indium phosphide (InP)-based waveguide, or a polymer-based waveguide. In addition, as a specific design example of the waveguide, a waveguide having a relative refractive index difference Δ of 2% will be described. The present embodiment is not limited to basic parameters of these waveguides, and the same concept can be applied to other parameters.

The WINC includes two arm waveguides between two directional couplers, and an optical path length difference ΔL is provided between the arm waveguides. As described above, polarization dependency exists due to wavelength dependency of the coupling ratio of the directional coupler. Therefore, in order to eliminate polarization dependency in the WINC, polarization dependency is given to a phase difference between the arm waveguides of the Mach-Zehnder interferometer. A transfer matrix for the WINC will be described below. Assuming that, in the Mach-Zehnder interferometer, C₁ is a transfer matrix of a first directional coupler, that A is a transfer matrix of the arm waveguide, and that C₂ is a transfer matrix of a second directional coupler, a transfer matrix M of the entire WINC is represented by the following expression.

$$M = {C}_{2} \cdot A \cdot {C}_{1} \qquad [ Math . 1 ]$$

Here, in a case where C₁, A, and C₂ are designed by a method in the related art, C₁, A, and C₂ are represented by the following expression.

$${C}_{1} = [ \begin{matrix}cos κ {z}_{1} & - j sin κ {z}_{1} \\ - j sin κ {z}_{1} & cos κ {z}_{1}\end{matrix} ] \qquad [ Math . 2 ]$$

$$A = [ \begin{matrix}exp j βΔ L & 0 \\ 0 & 1\end{matrix} ]$$

$${C}_{2} = [ \begin{matrix}cos κ {z}_{2} & - j sin κ {z}_{2} \\ - j sin κ {z}_{2} & cos κ {z}_{2}\end{matrix} ]$$

Here, K is a coupling ratio of the directional coupler, β is a propagation constant of the arm waveguide, ΔL is an optical path length difference between the two arm waveguides, and z₁ and z₂ are coupling lengths of coupling portions of the directional couplers.

In a case where an optical signal is input to one input waveguide of the first directional coupler of the WINC, a vector of the input is [1, 0]^{t}. Thus, by using the above expression, a branching intensity (coupling ratio) I of the WINC is represented by the following expression.

$$[ Math . 3 ]$$

$$I = {sin}^{2} κ {z}_{2} {cos}^{2} κ {z}_{1} + {cos}^{2} κ {z}_{2} {sin}^{2} κ {z}_{1} - 2 sin κ {z}_{2} cos κ {z}_{1} cos κ {z}_{2} sin κ {z}_{1} cos βΔ L \qquad ( 1 )$$

Thus, in a case where the coupling ratio κ of the directional coupler has polarization dependency, a branching ratio in the WINC also has polarization dependency.

Therefore, in order to eliminate polarization dependency in the WINC, there are a method of using an asymmetric directional coupler and a method of providing a difference between widths of the two arm waveguides. These methods will be described in order below.

### First Embodiment

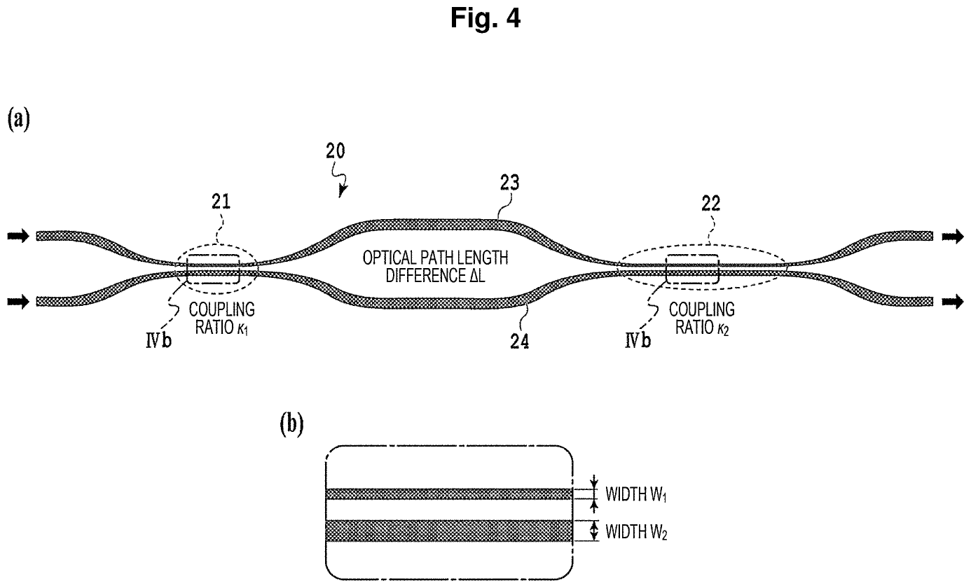

FIG. 4 illustrates a configuration of the WINC according to a first embodiment. FIG. 4(a) illustrates the overall configuration, and FIG. 4(b) illustrates an enlarged view of the directional coupler. The WINC 20 is configured with a Mach-Zehnder interferometer including two arm waveguides 23 and 24 between two directional couplers 21 and 22. An optical path length difference ΔL is provided between the arm waveguide 23 (long arm) and the arm waveguide 24 (short arm). The directional couplers 21 and 22 are asymmetric directional couplers, and waveguide widths of the two waveguides at the coupling portion are different from each other. As illustrated in FIG. 4(b), it is assumed that a waveguide width on a side of the arm waveguide 23 of the long arm is W₁ and a waveguide width on a side of the arm waveguide 24 of the short arm is W₂.

In a symmetric directional coupler in which waveguide widths of two waveguides included in the directional coupler are the same, a phase relationship between optical signals output from the two output waveguides is always 90°. On the other hand, the asymmetric directional coupler has a phase difference in which the output phase is obtained by a transfer matrix represented by the following expression. That is, the transfer matrix C is represented by the following expression.

$$[ Math . 4 ]$$

$$C = [ \begin{matrix}cos qz + j \frac{δ}{q} sin qz & - j \frac{κ}{q} sin qz \\ - j \frac{κ}{q} sin qz & cos qz - j \frac{δ}{q} sin qz\end{matrix} ] \qquad ( 2 )$$

$$q = \sqrt{{κ}^{2} + {δ}^{2}} ,$$

$$δ = \frac{{β}_{1} - {β}_{2}}{2}$$

Here, κ is a coupling ratio, and β₁ and β₂ are propagation constants of the two waveguides included in the directional coupler. Further, z is a coupling length of the directional coupler. Assuming that a length of a coupling portion in a case where an optical signal which is input to one input waveguide of the directional coupler at a wavelength is 100% coupled to the other waveguide is a complete coupling length Lc, the coupling ratio κ has a relationship represented by the following expression.

$${L}_{C} = \frac{π}{2 κ} \qquad [ Math . 5 ]$$

In a symmetric directional coupler that is commonly used, in the above expression, β₁=β₂, that is, δ=0. Thus, the transfer matrix C is simplified as the following expression.

$$C = [ \begin{matrix}cos κ z & - j sin κ z \\ - j sin κ z & cos κ z\end{matrix} ] \qquad [ Math . 6 ]$$

The phase relationship between the optical signals output from the two output waveguides is always fixed to π/2 [rad].

On the other hand, as illustrated in FIG. 4, in a case where the widths of the two optical waveguides included in the coupling portion of the directional coupler are asymmetric, the propagation constants β₁ and β₂ of the two optical waveguides are different from each other. Therefore, as can be obtained from the expression (2), the phase relationship ϕ is represented by, for example, the following expression.

$$\begin{matrix}ϕ = a tan [ - j \frac{κ}{q} sin qz ] - a tan \frac{j \frac{δ}{q} sin qz}{cos qz} \\ = \frac{π}{2} - a tan \frac{j \frac{δ}{q} sin qz}{cos qz}\end{matrix} \qquad [ Math . 7 ]$$

The phase relationship ϕ changes by δ.

By making the widths W₁ and W₂ of the optical waveguides of the coupling portion asymmetric, the propagation constants β₁ and β₂ of the two optical waveguides are different from each other. Further, the phase relationship between the optical signals output from the output waveguides is changed from π/2. As described above, since the coupling ratio varies depending on polarization, the generated phase difference may also have polarization dependency. By adjusting the phase relationship ϕ, the polarization dependency of the coupling portion of the directional coupler that is described in first to third terms on a right side of the expression (1) is compensated for. Thereby, the polarization dependency in the WINC is eliminated.

Note that, in the first embodiment, in the asymmetric directional coupler, the waveguide width on the long arm side is narrow and the waveguide width on the short arm side is wide. On the other hand, depending on settings of the optical path length difference between the arm waveguides and the coupling ratio of the directional coupler, the configuration may be reversed as long as the waveguide widths of the two waveguides are different from each other.

### Second Embodiment

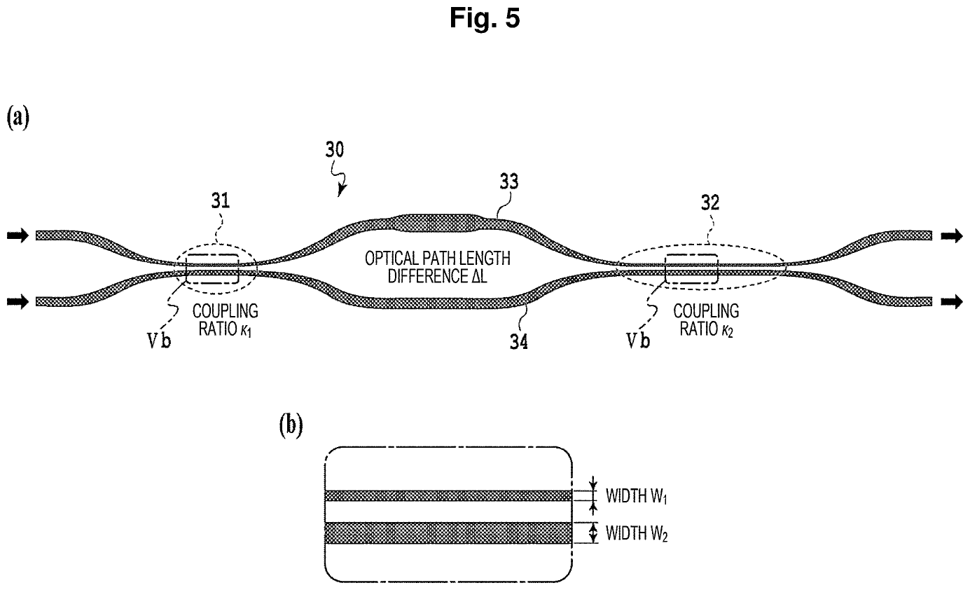

FIG. 5 illustrates a configuration of the WINC according to a second embodiment. FIG. 5(a) illustrates the overall configuration, and FIG. 5(b) illustrates an enlarged view of the directional coupler. The WINC 30 is configured with a Mach-Zehnder interferometer including two arm waveguides 33 and 34 between two directional couplers 31 and 32. An optical path length difference ΔL is provided between the arm waveguide 33 (long arm) and the arm waveguide 34 (short arm). Further, a portion of the arm waveguide 33 has a waveguide width WB wider than widths W of the two arm waveguides. Similarly to the first embodiment, the directional couplers 31 and 32 are asymmetric directional couplers. It is assumed that the waveguide width on the long arm side is W₁ and the waveguide width on the short arm side is W₂.

In the expression (1), in order to eliminate the polarization dependency in the WINC, a method of compensating the polarization dependency by giving polarization dependency to a phase term caused by the arm portion, that is, cos βΔL of a third term on the right side is also effective. By compensating the total polarization dependency by giving polarization dependency to the phase term of cos βΔL and matching the given polarization dependency with the polarization dependency of the coupling portion of the directional coupler that is described in the first to third terms on the right side, the polarization dependency in the WINC is eliminated. In the second embodiment, the asymmetric directional coupler is used, and a difference in the waveguide widths of the two arm waveguides is provided. Thereby, the propagation constant β has polarization dependency.

Note that, in the second embodiment, the waveguide width on the long arm side is wider than a normal waveguide width. On the other hand, the waveguide width on the short arm side may be narrower than a normal waveguide width. In addition, depending on settings of the optical path length difference between the arm waveguides and the coupling ratio of the directional coupler, the relationship of the wide/narrow waveguide width may be reversed as long as the waveguide widths of the two waveguides are different from each other such that the polarization dependency is eliminated.

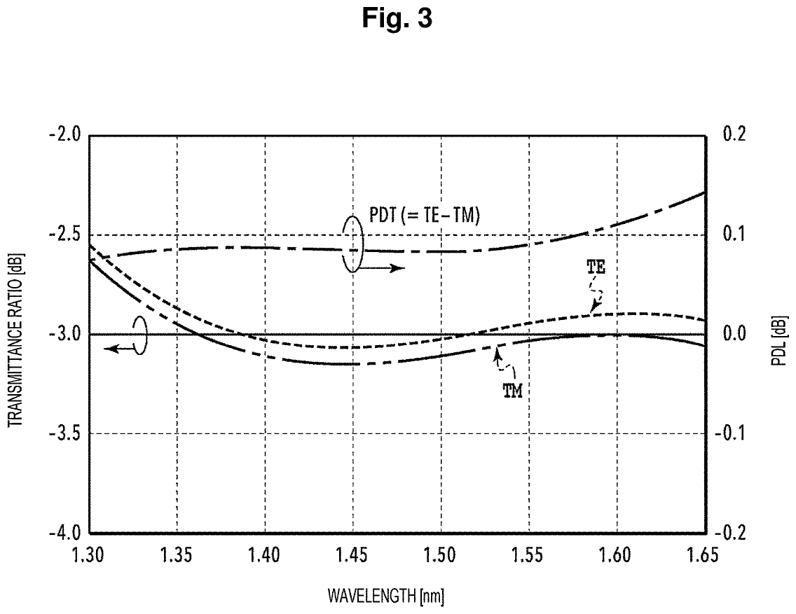

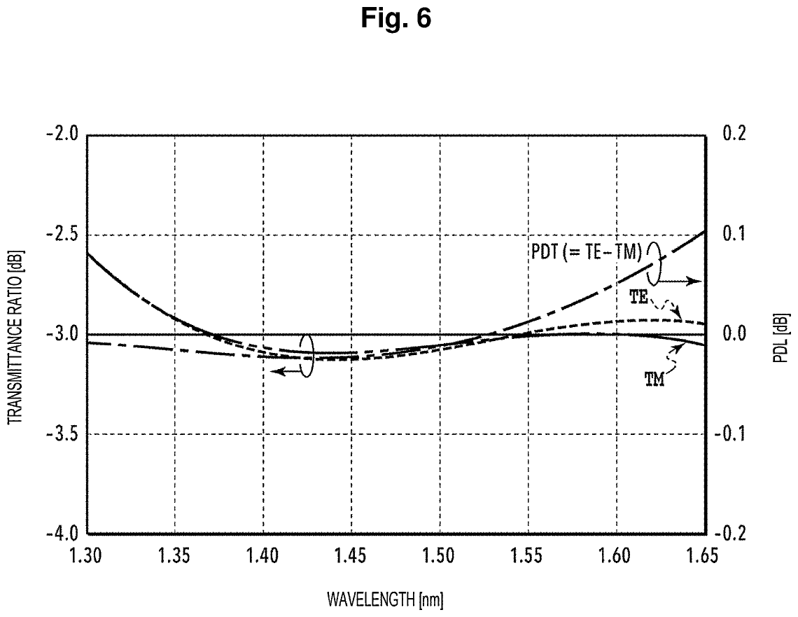

FIG. 6 illustrates a wavelength characteristic of the WINC according to the second embodiment. This is a result obtained by calculating a wavelength characteristic in a case where the widths W₁ and W₂ of the waveguides included in the two directional couplers 31 and 32 are asymmetric, where the waveguide width on the long arm side is set to W₁, and where polarization dependency is given to the phase term caused by the arm portion. As can be seen from a comparison with FIG. 3, the PDL and the PDT of the TE polarization and the TM polarization are greatly improved in a wavelength of the wavelength band used in the optical communication.

According to the first embodiment and the second embodiment, it is possible to provide a waveguide type optical coupler which has a wavelength dependency, in which polarization dependency are eliminated, and which maintains a constant branching ratio in a wide wavelength region.

1. A waveguide type optical coupler comprising a Mach-Zehnder interferometer that includes two arm waveguides between two directional couplers,
wherein waveguide widths of a two waveguides in a coupling portion of the directional coupler are different from each other.

2. The waveguide type optical coupler according to claim 1, wherein a waveguide width of a portion of one arm waveguide of the two arm waveguides is different from a waveguide width of the other arm waveguide.
